(19) United States
(12) Patent Application Publication
(10) Pub. No.: US 2025/0214153 A1
(43) Pub. Date: Jul. 3, 2025

(54) DOWELING JIG SYSTEM

(71) Applicant: Kreg Enterprises, Inc., Ankeny, IA (US)

(72) Inventors: Zachary Scheuffele, Ames, IA (US); Nathan Hagarty, Des Moines, IA (US); Andrew Lyons, Grimes, IA (US); Kevin Choi, Ames, IA (US)

(21) Appl. No.: 18/989,203

(22) Filed: Dec. 20, 2024

Related U.S. Application Data
(60) Provisional application No. 63/615,331, filed on Dec. 28, 2023.

(51) Int. Cl. B23B 47/28

(52) U.S. Cl. CPC B23B 47/288

(57) ABSTRACT

In one or more arrangements, a doweling jig system is presented having a drill guide block and an alignment member operably connected to the drill guide block. The drill guide block includes one or more drill guides. The alignment member is configured to engage a surface of a workpiece component. In one or more arrangements, the alignment member has one or more alignment features configured to facilitate positioning of alignment member along the surface of the workpiece component to facilitate the positioning of the one or more drill guides for drilling a dowel hole in the workpiece component. In one or more arrangements, the drill guide block is selectably detachable from alignment member, for example, for storage, transportation, and/or interchanging between a plurality of different drill guide blocks configured for drilling different size dowel holes.

### CROSS REVERENCE TO RELATED APPLICATIONS

This application claims priority to U.S. Provisional Patent Application No. 63/615,331, filed Dec. 28, 2023, and titled “DOWLING JIG SYSTEM”, the entirety of which is hereby fully incorporated by reference herein.

### FIELD OF THE DISCLOSURE

This disclosure relates generally to woodworking tools. More specifically and without limitation, this disclosure relates to jigs for woodworking tools.

### OVERVIEW OF THE DISCLOSURE

In woodworking, various wood joinery technique may be used to interconnect various components of a workpiece including but not limited to, for example, butt joints, miter buts, half-lap, tongue and groove, mortise and tenon, dovetail joint, rabbet joints, pocket hole joints, biscuits, and dowels to name a few. Some joinery techniques utilize fasteners (e.g., screws, nails, bolts, brackets, and/or other hardware) to connect and/or reinforce the connection of the workpiece components at the joint. Some other joinery techniques interconnect workpiece components without utilizing fasteners, for example, using adhesive (e.g., glue).

Dowels are one particularly popular joinery method that uses interconnection workpiece components using dowels inserted into adjacent dowel holes of the components as the components are mated together. Dowels may be sized to be frictionally held within the adjacent dowel holes, thereby joining the components together. Additionally or alternatively, adhesives are often used to adhere dowels in place within dowel holes to provide a stronger connection.

Dowel joinery provides many advantages leading to its popularity. As one example, down joinery is hidden from view when a workpiece is assembled, thereby facilitating a more aesthetically pleasing appearance. Additionally or alternatively, dowel joinery can be easily used in combination with fasteners or other wood joinery techniques to increase strength of workpiece joints. Furthermore, some wood smiths may prefer traditional wood joinery techniques such as dowels that do not require metallic fasteners or other hardware.

Despite the advantages of dowels, drilling of dowel holes can be challenging. For example, if dowel holes are too shallow, the dowel will prevent the workpiece components from being fully mated together, leaving an unsightly gap and providing a weaker strength joint. Conversely, if dowel holes are too deep, the dowels may be inadvertently inserted too far into one of the components when mated, thereby reducing the length of dowel connected with the other component and reducing the strength of the joint.

Furthermore, it can be difficult to drill dowel holes in a pair of components, so the holes are aligned when the components are mated together. Even slight misalignment of dowel holes can create a visibly crooked or uneven joint or may prevent the components from being mated entirely.

Existing commercially available doweling jigs for drilling dowel holes can be difficult and complicated to use. Such difficulty/complexity often requires many users to review the set-up instructions before use and even when doing so users are often confused and unsure of themselves. In addition, when doweling jig systems are set up, it is difficult for a user to know if the jig and drill bit are properly configured for their intended use. This often requires the user to do a test run before use to ensure that the jig and drill bit are properly set up for the workpieces they are using. This takes an unnecessary amount of time and unnecessarily consumes material and screws. In addition, due to the complexity and not-intuitive nature of the set-up process, doweling jigs are often set up for non-optimal drilling of dowel holes. When this occurs, the resulting joint may be misaligned, unsightly, and/or not as strong as it could otherwise be.

As such, for all these reasons existing doweling jig systems are too difficult to set-up, they are too time consuming to set up and they are too easy to improperly set-up.

Therefore, for all the reasons stated above, and the reasons stated below, there is a need in the art for a doweling jig system that improves upon the state of the art.

Another object of the disclosure is to provide a doweling jig system that provides improved functionality over prior art systems.

Yet another object of the disclosure is to provide a doweling jig system that provides improved features over prior art systems.

Another object of the disclosure is to provide a doweling jig system that is relatively inexpensive.

Yet another object of the disclosure is to provide a doweling jig system that is easy to use.

Another object of the disclosure is to provide a doweling jig system that is intuitive to use.

Yet another object of the disclosure is to provide a doweling jig system that is strong and robust.

Another object of the disclosure is to provide a doweling jig system that can be used in many applications.

Yet another object of the disclosure is to provide a doweling jig system that improves efficiencies.

Another object of the disclosure is to provide a doweling jig system that provides unique functionality.

Yet another object of the disclosure is to provide a doweling jig system that is fast to use and fast to set-up.

Another object of the disclosure is to provide a doweling jig system that is safe to use.

Yet another object of the disclosure is to provide a doweling jig system that saves time.

Another object of the disclosure is to provide a doweling jig system that has a compact size.

Yet another object of the disclosure is to provide a doweling jig system that can be used with different thickness workpieces and/or different size dowels.

Another object of the disclosure is to provide a doweling jig system that has a long useful life.

Yet another object of the disclosure is to provide a doweling jig system that improves the quality of the products made using the device.

Another object of the disclosure is to provide a doweling jig system that is high quality.

These and other objects, features, or advantages of the disclosure will become apparent from the specification, figures and claims.

### BRIEF DESCRIPTION OF THE FIGURES:

FIG. 1 shows an upper rear right perspective view of a doweling jig system, in accordance with one or more arrangements; the view showing a drill guide block and alignment member of the doweling jig system detached from each other.

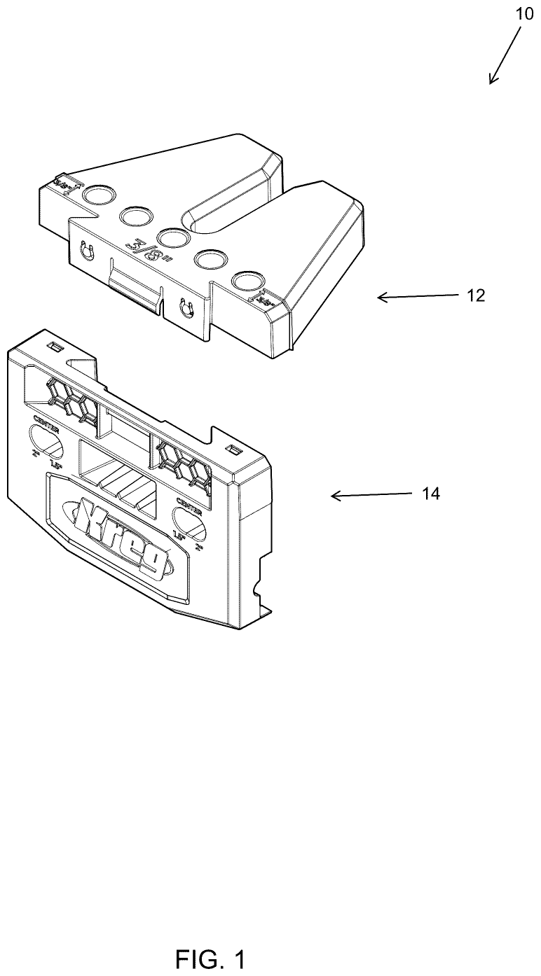

FIG. 2 shows an upper rear right perspective view of a doweling jig system, in accordance with one or more arrangements; the view showing a drill guide block and alignment member of the doweling jig system attached to each other.

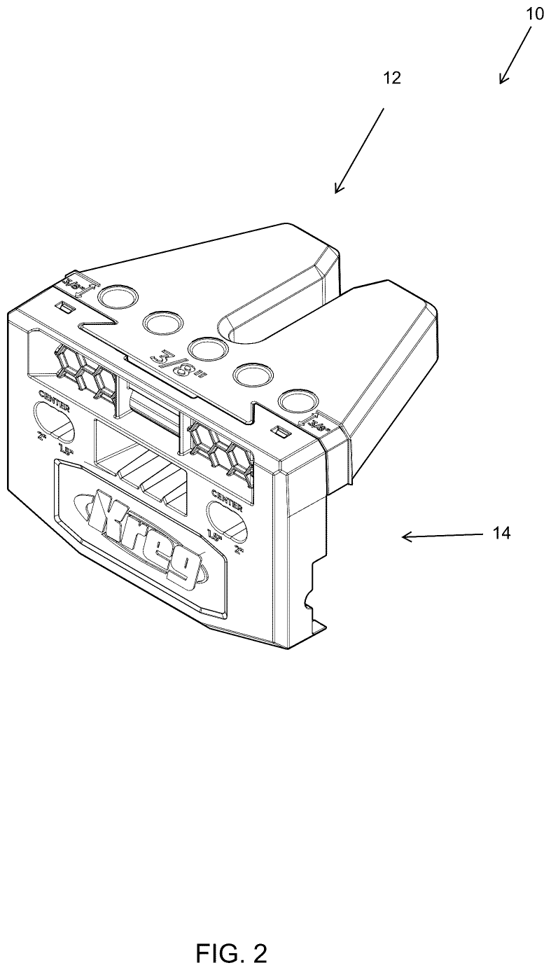

FIG. 3 shows an upper rear left perspective view of a doweling jig system, in accordance with one or more arrangements; the view showing a drill guide block and alignment member of the doweling jig system detached from each other.

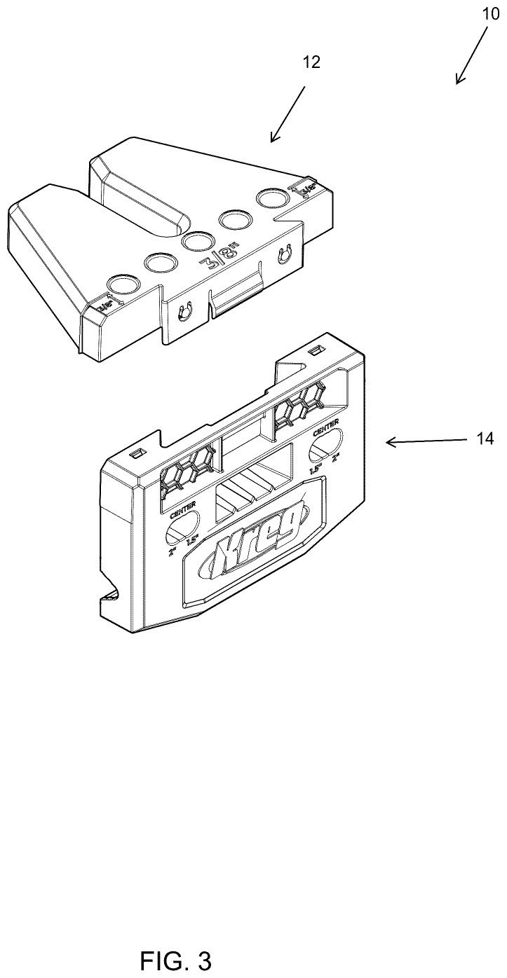

FIG. 4 shows a front view of a doweling jig system, in accordance with one or more arrangements.

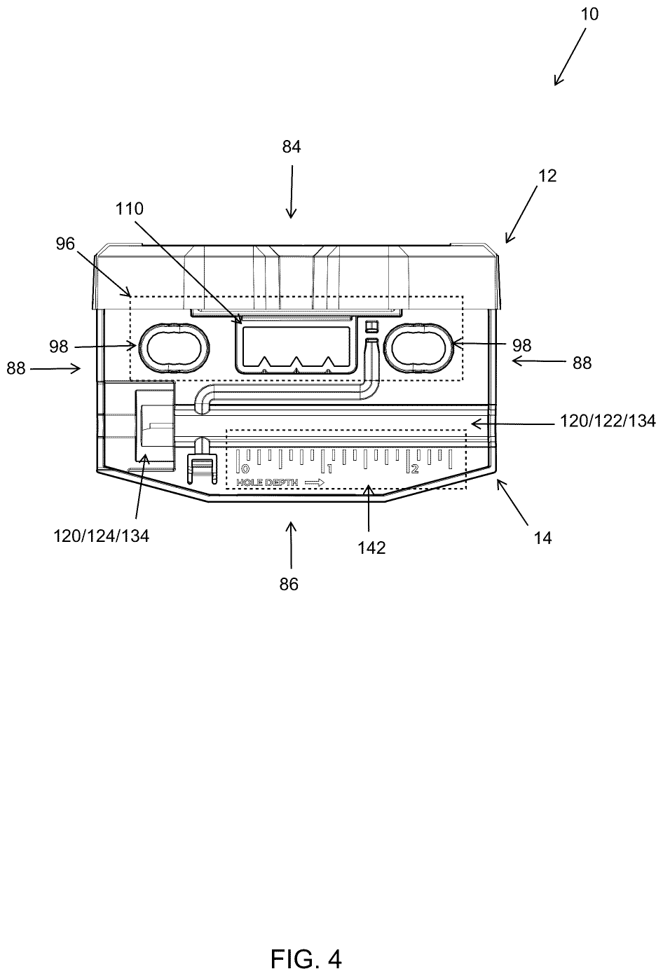

FIG. 5 shows a partial front view of a doweling jig system, in accordance with one or more arrangements; the view showing a close up of alignment features of the alignment member.

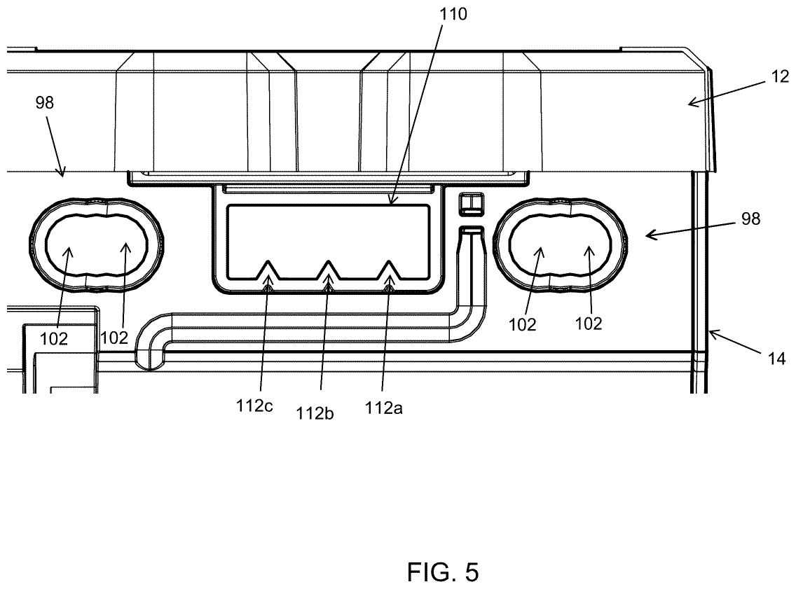

FIG. 6 shows a lower front right perspective view of a doweling jig system, in accordance with one or more arrangements.

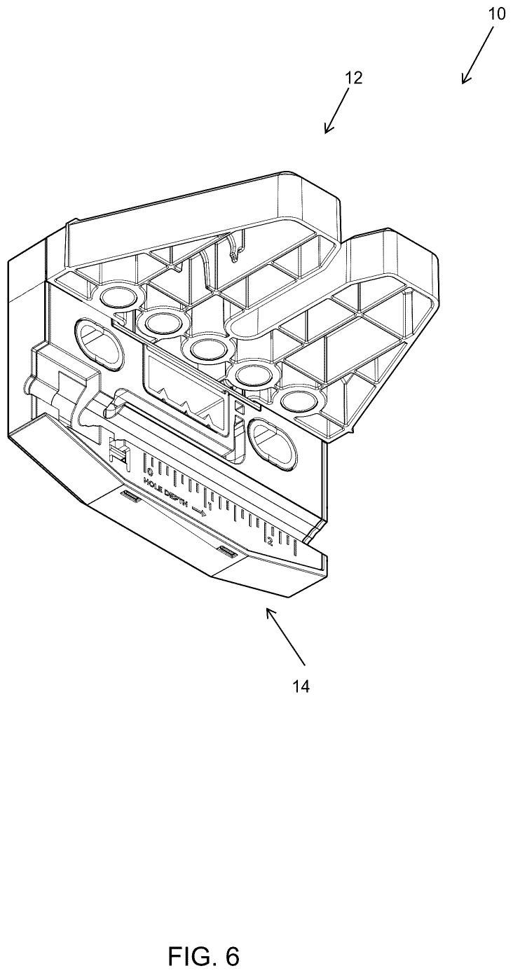

FIG. 7 shows a lower front left perspective view of a doweling jig system, in accordance with one or more arrangements.

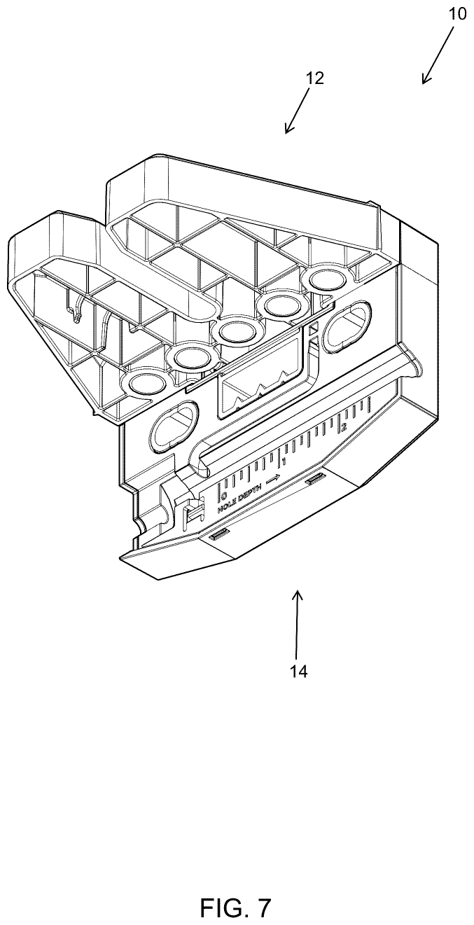

FIG. 8 shows a lower rear right perspective view of a doweling jig system, in accordance with one or more arrangements.

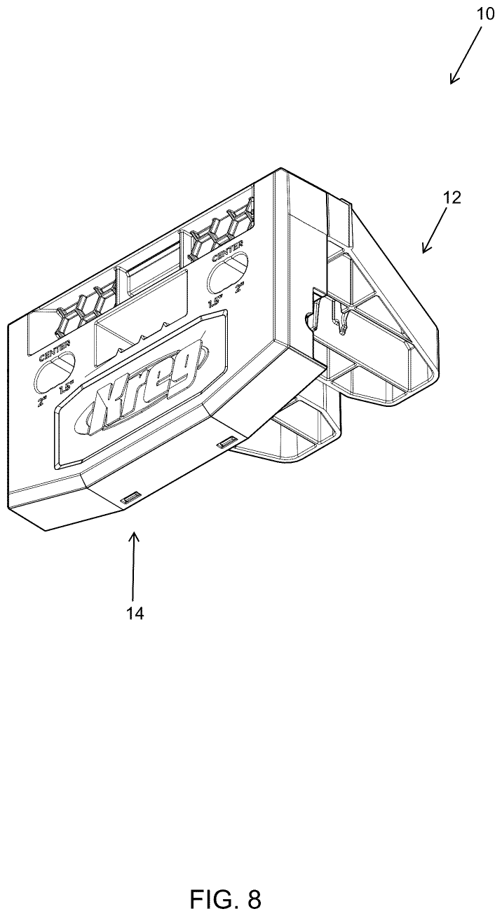

FIG. 9 shows a lower left right perspective view of a doweling jig system, in accordance with one or more arrangements.

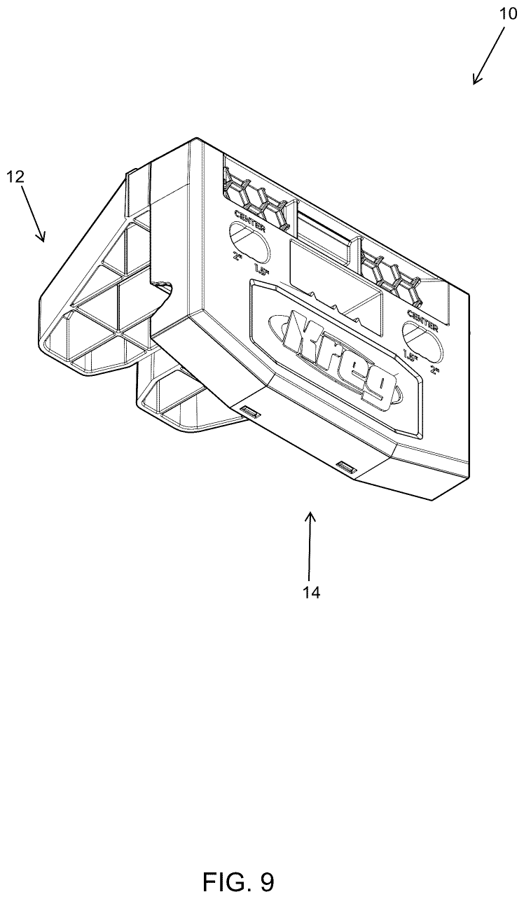

FIG. 10 shows a bottom view of a doweling jig system, in accordance with one or more arrangements.

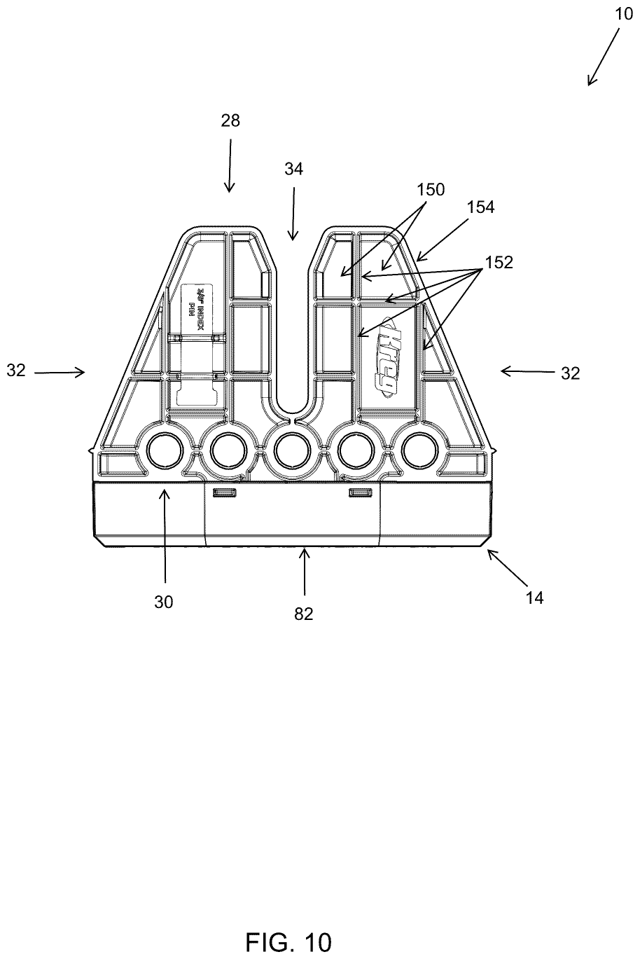

FIG. 11 shows a lower front right perspective view of a doweling jig system, in accordance with one or more arrangements; the view showing a drill guide block and alignment member of the doweling jig system detached from each other.

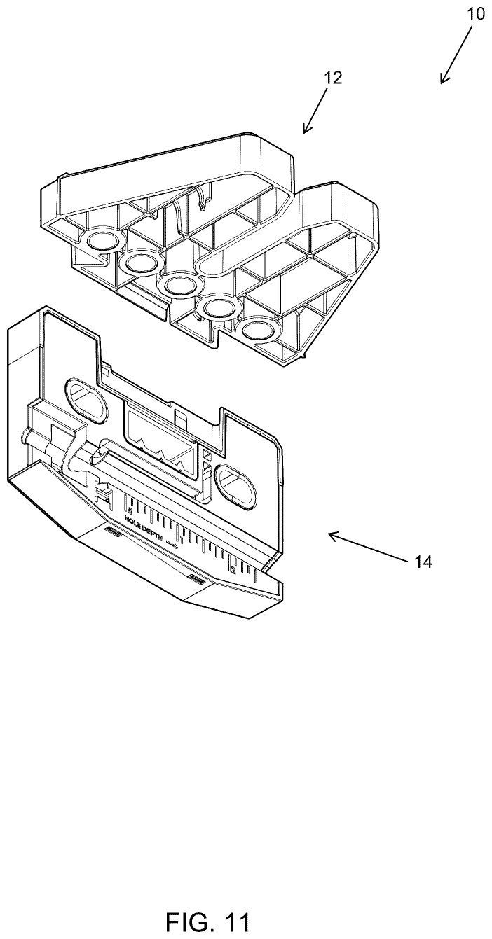

FIG. 12 shows a lower front left perspective view of a doweling jig system, in accordance with one or more arrangements; the view showing a drill guide block and alignment member of the doweling jig system detached from each other.

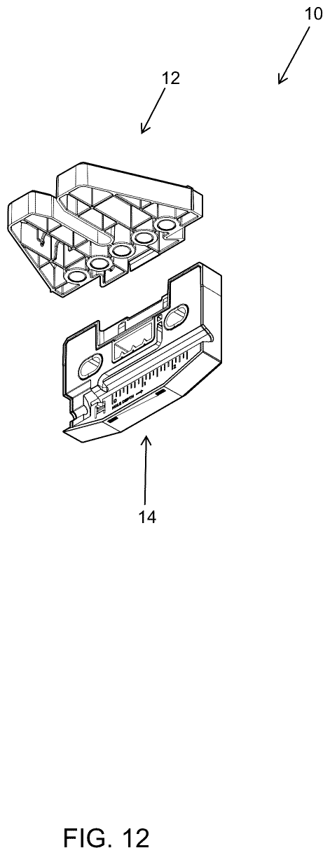

FIG. 13 shows a rear view of a doweling jig system, in accordance with one or more arrangements.

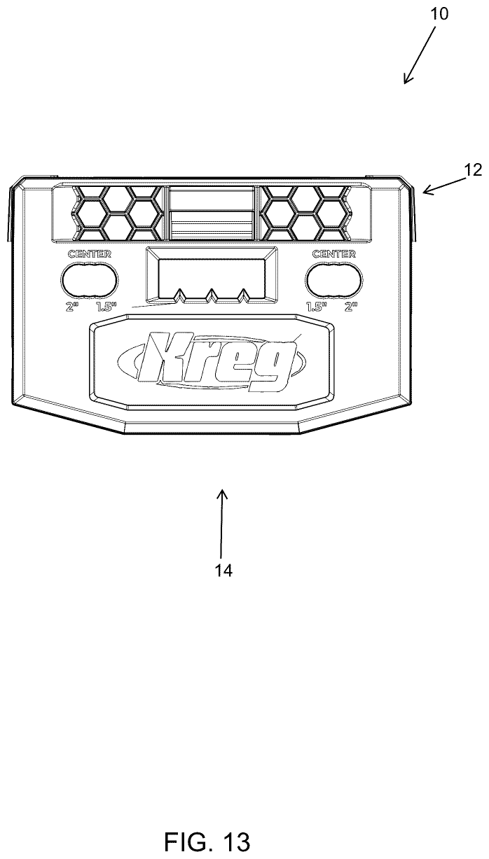

FIG. 14 shows a right side view of a doweling jig system, in accordance with one or more arrangements.

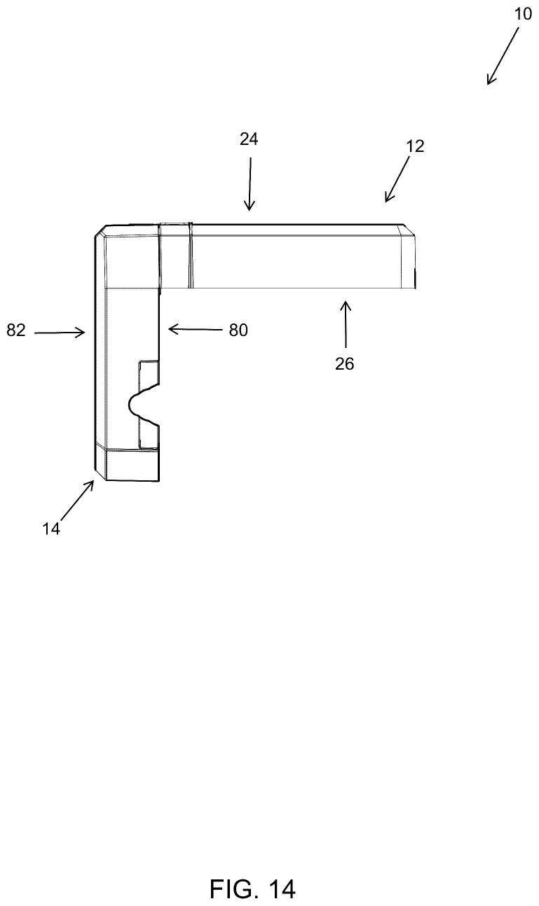

FIG. 15 shows a left side view of a doweling jig system, in accordance with one or more arrangements.

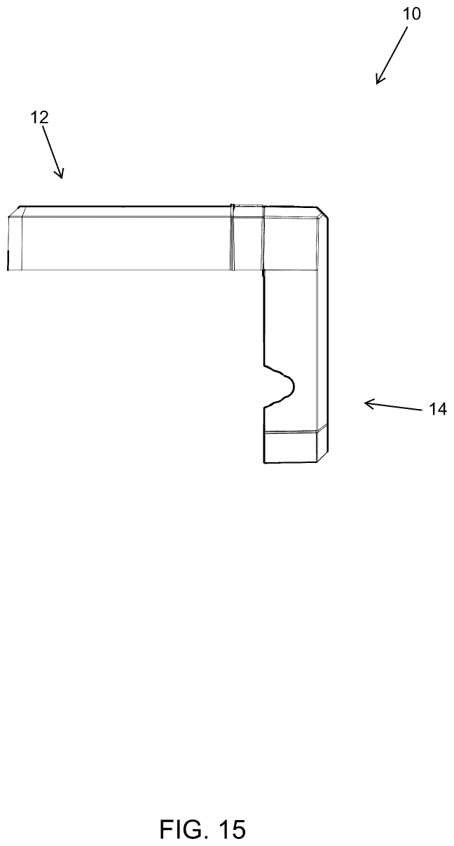

FIG. 16 shows a cross section right side view of a doweling jig system, in accordance with one or more arrangements.

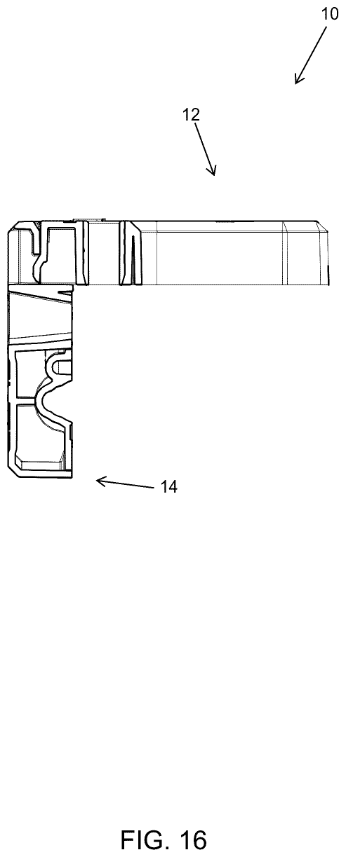

FIG. 17 shows a cross section right side view of a doweling jig system, in accordance with one or more arrangements; the view showing cylindrical surfaces of a stepped cylindrical shaped recess of an alignment member of the doweling jig system.

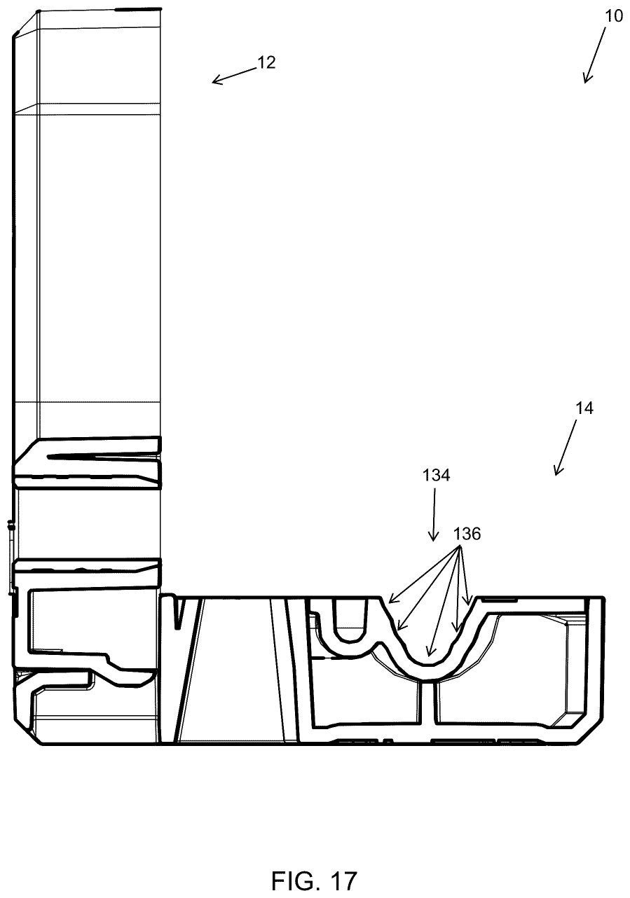

FIG. 18 shows a cross section upper rear right perspective view of a doweling jig system, in accordance with one or more arrangements.

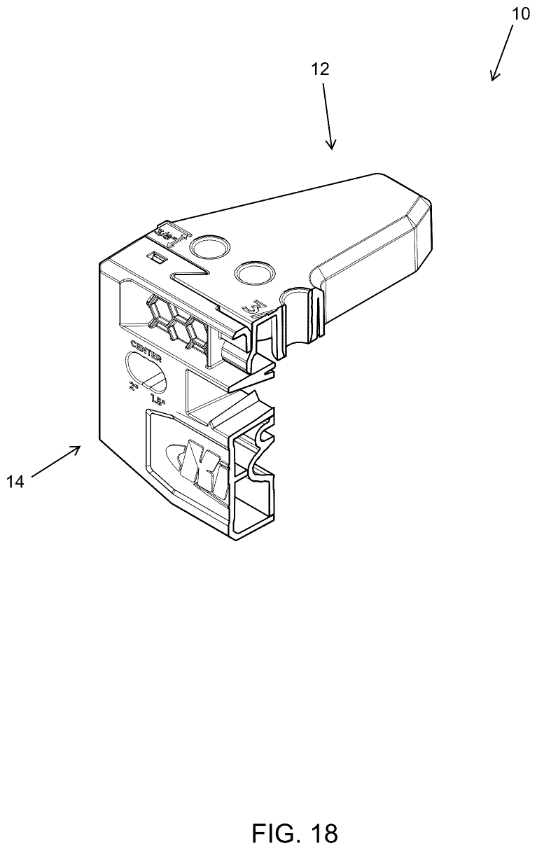

FIG. 19 shows a right side view of a doweling jig system, in accordance with one or more arrangements; the view showing a stepped cylindrical shaped recess of an alignment member configured to hold drill bits of different diameters; the view showing the alignment member having a magnet configured to hold a drill bit in the stepped cylindrical shaped recess.

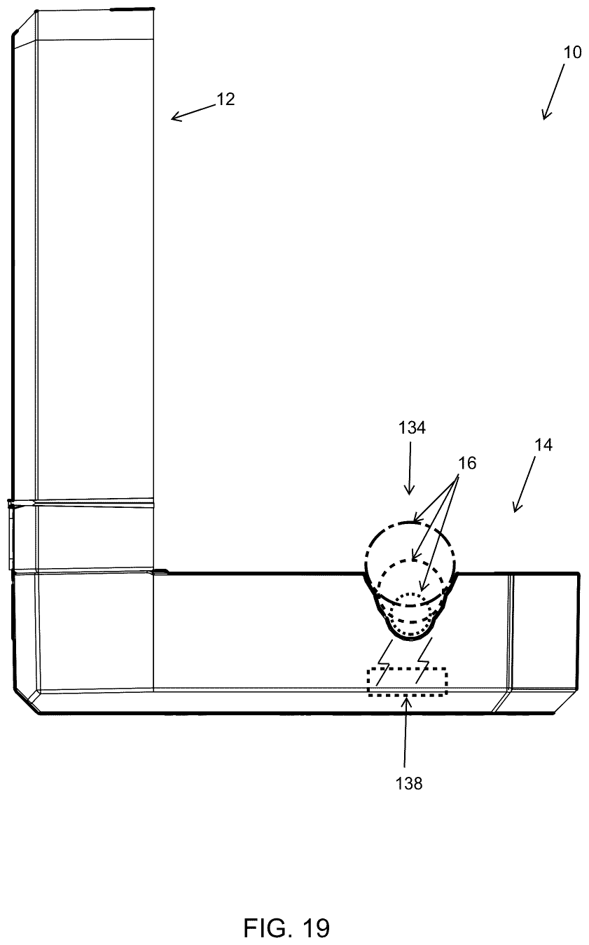

FIG. 20 shows a cross section view of the doweling jig system shown in FIG. 19, in accordance with one or more arrangements.

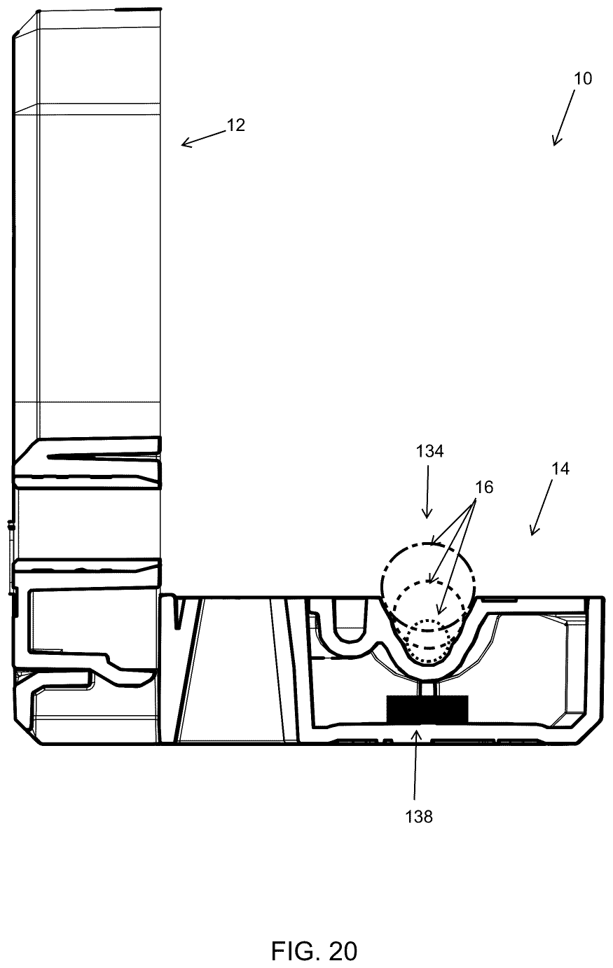

FIG. 21 shows an upper front right perspective view of a doweling jig system, in accordance with one or more arrangements.

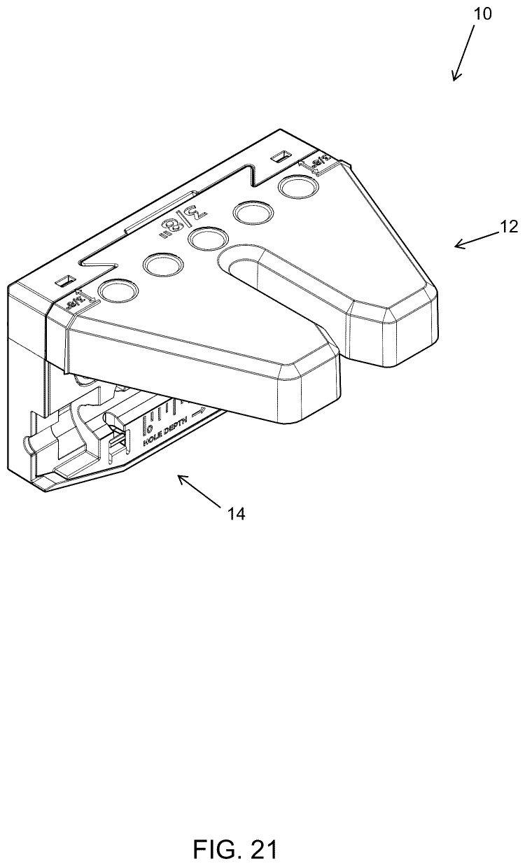

FIG. 22 shows an upper front left perspective view of a doweling jig system, in accordance with one or more arrangements.

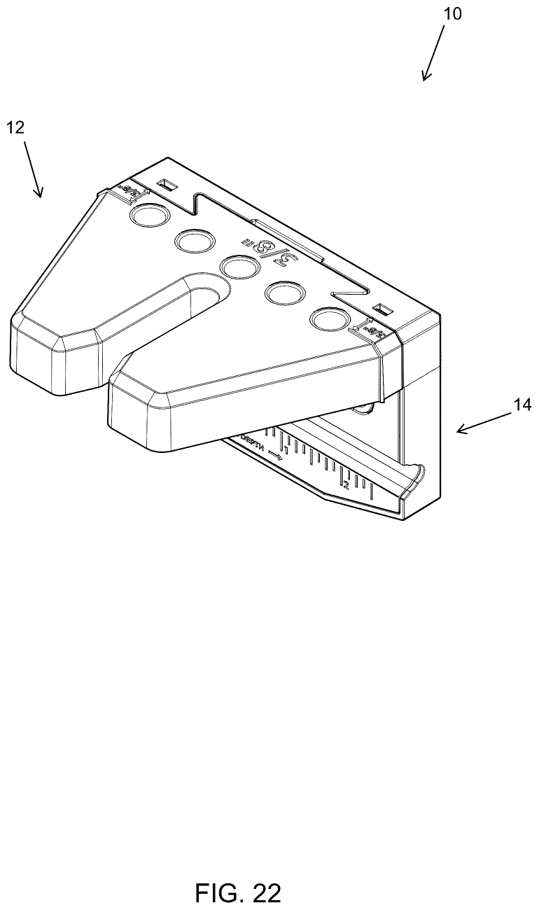

FIG. 23 shows an upper rear left perspective view of a doweling jig system, in accordance with one or more arrangements.

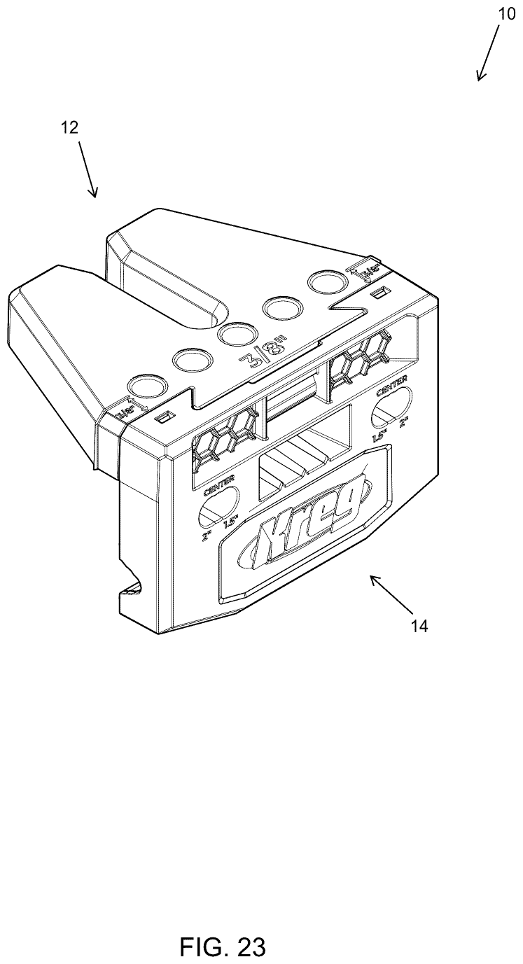

FIG. 24 shows a top view of a doweling jig system, in accordance with one or more arrangements.

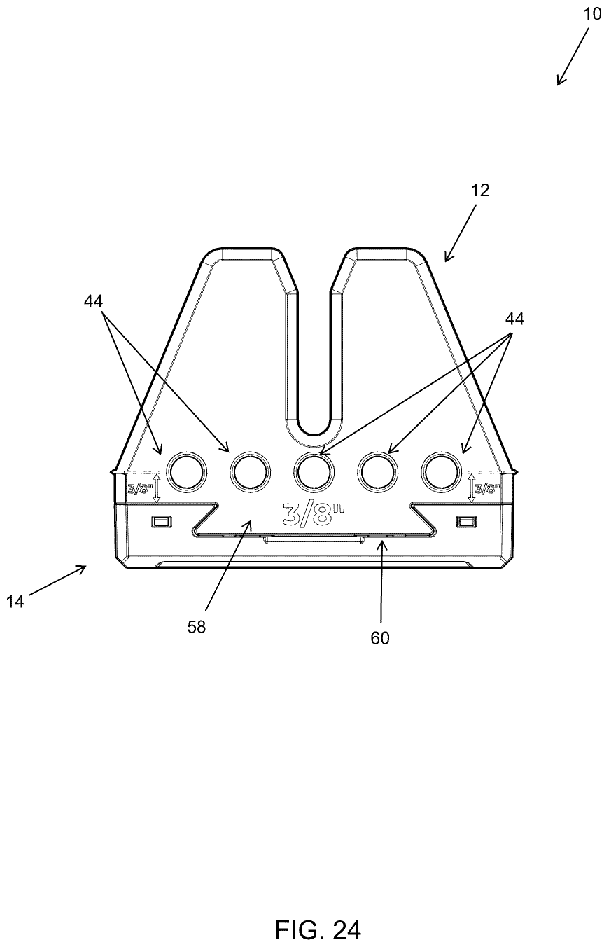

FIG. 25 shows an upper rear left perspective view of a doweling jig system, in accordance with one or more arrangements; the view showing a cross section of an alignment member of the doweling jig system; the view showing a drill bit positioned in a stepped cylindrical shaped recess of the alignment member.

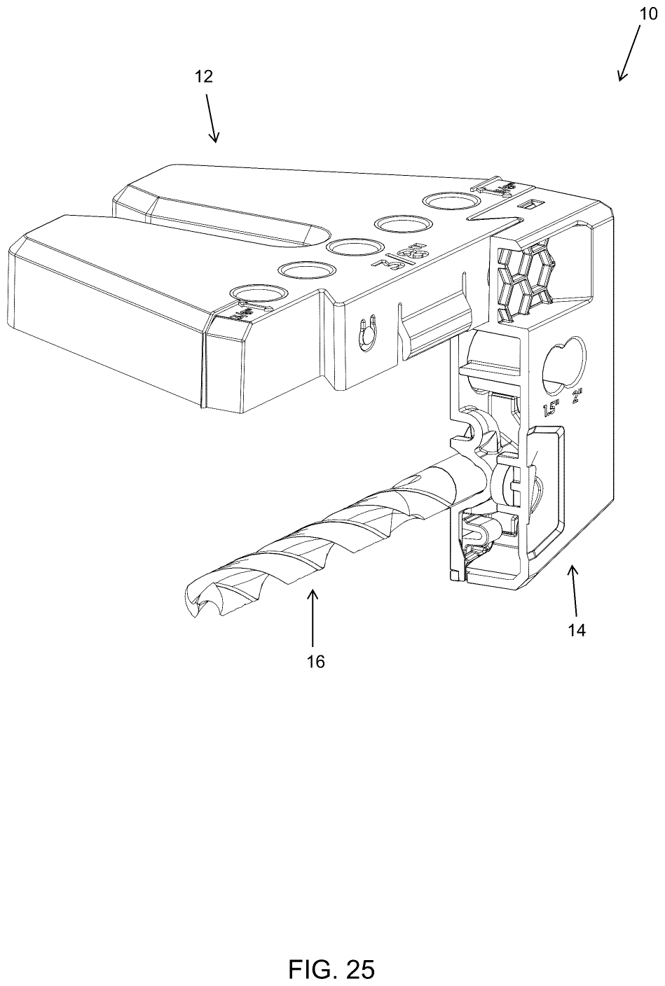

FIG. 26 shows an upper rear left perspective view of a doweling jig system, in accordance with one or more arrangements; the view showing a drill bit positioned in a stepped cylindrical shaped recess of the alignment member.

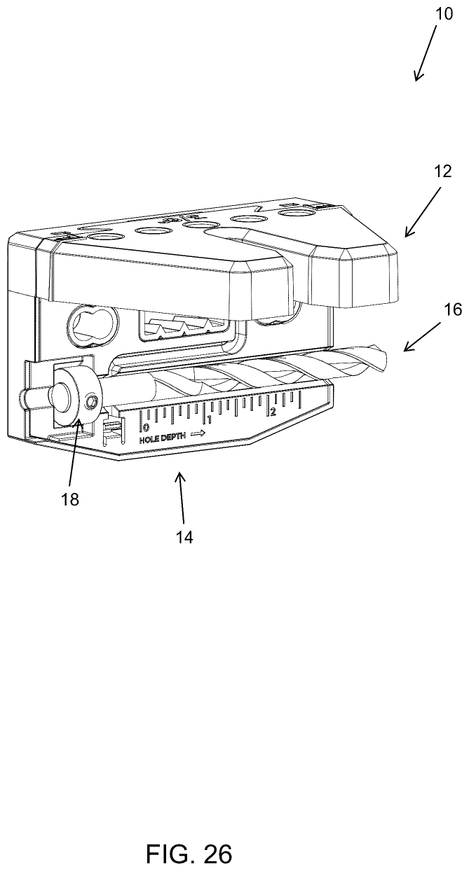

FIG. 27 shows a top view of three drill guide blocks configured to connect with an alignment member of a doweling jig system, in accordance with one or more arrangements.

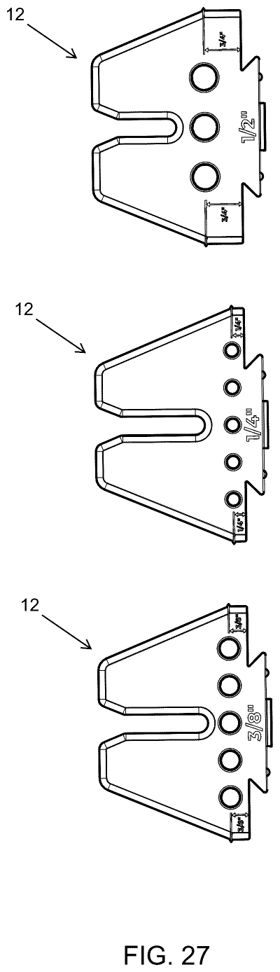

FIG. 28 shows a bottom view of a drill guide block of a doweling jig system, in accordance with one or more arrangements.

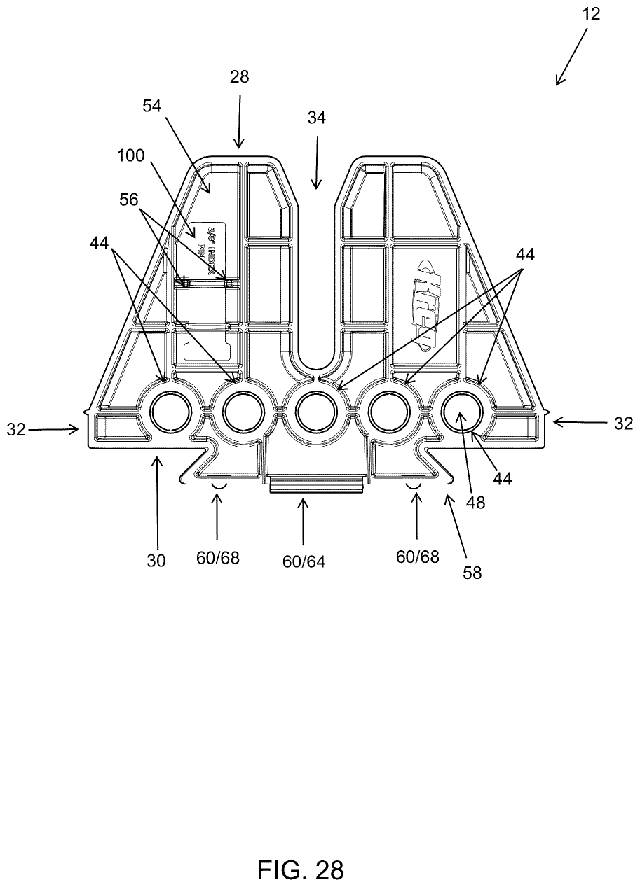

FIG. 29 shows a rear view of a drill guide block of a doweling jig system, in accordance with one or more arrangements.

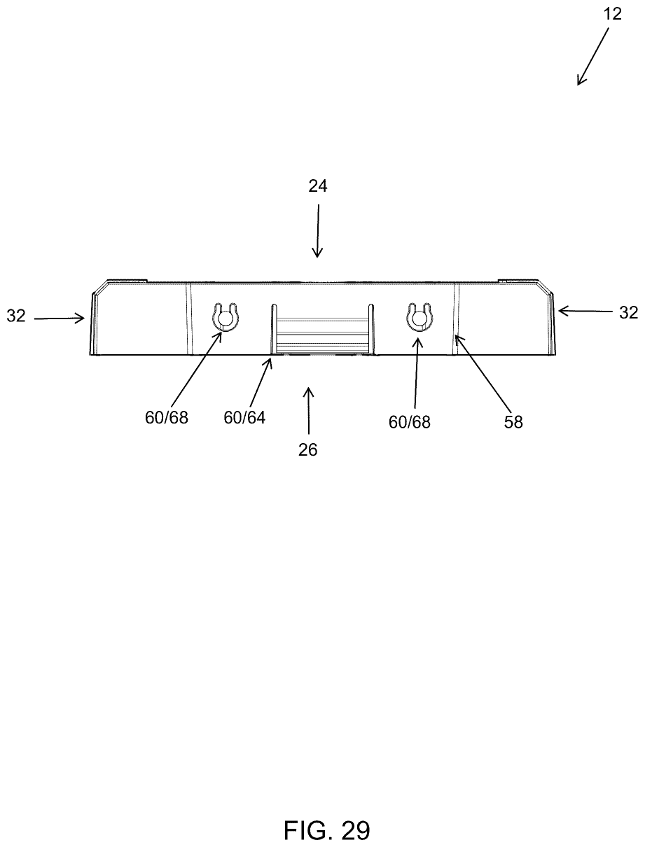

FIG. 30 shows a top view of a drill guide block of a doweling jig system, in accordance with one or more arrangements.

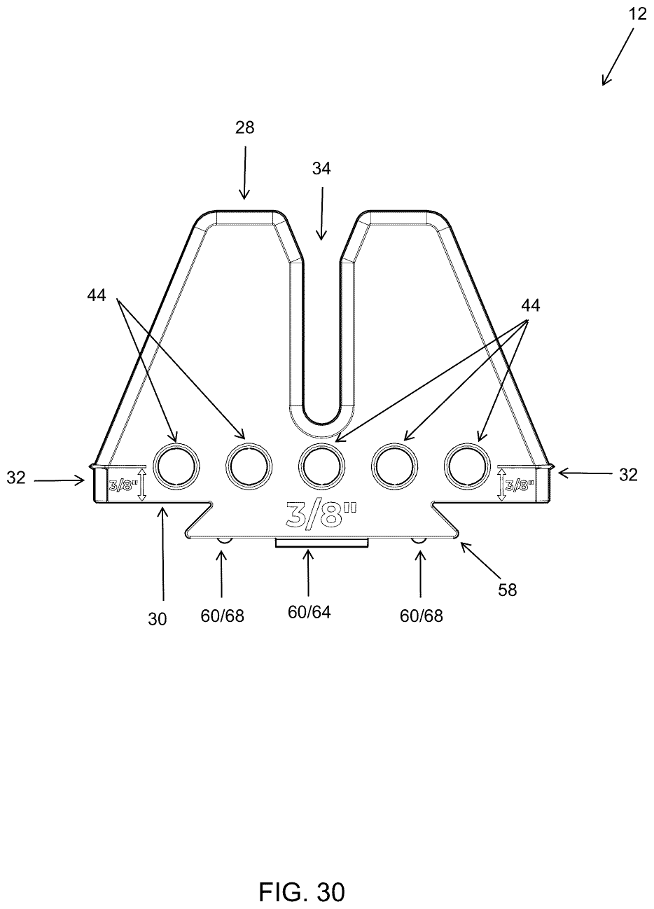

FIG. 31 shows an upper front right perspective view of a doweling jig system, in accordance with one or more arrangements; the view showing a front surface member detached from an alignment member.

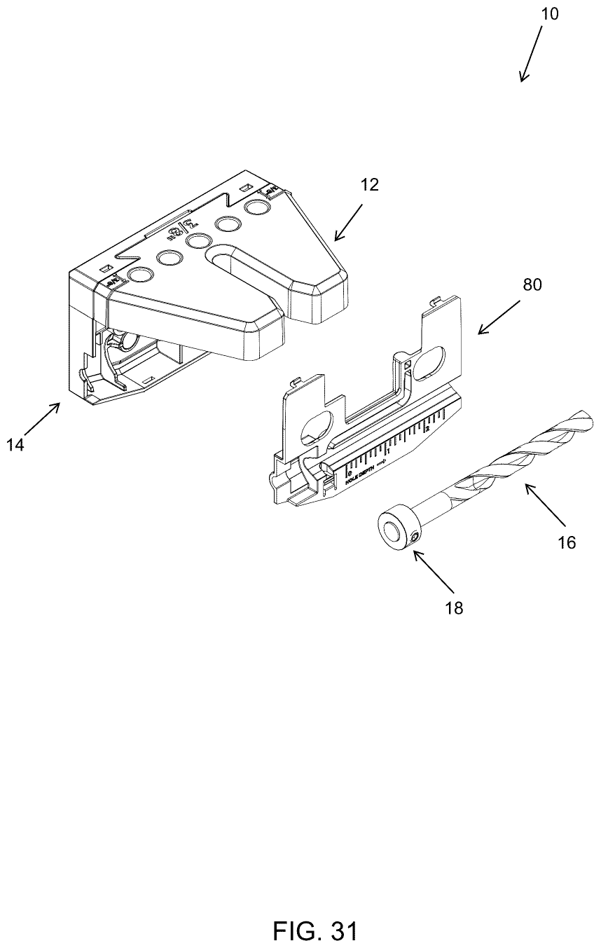

FIG. 32 shows a front view of a doweling jig system, in accordance with one or more arrangements; the view showing an index pin positioned in a pin hole alignment feature of an alignment member; the view showing the system positioned on a workpiece for drilling of a dowel hole.

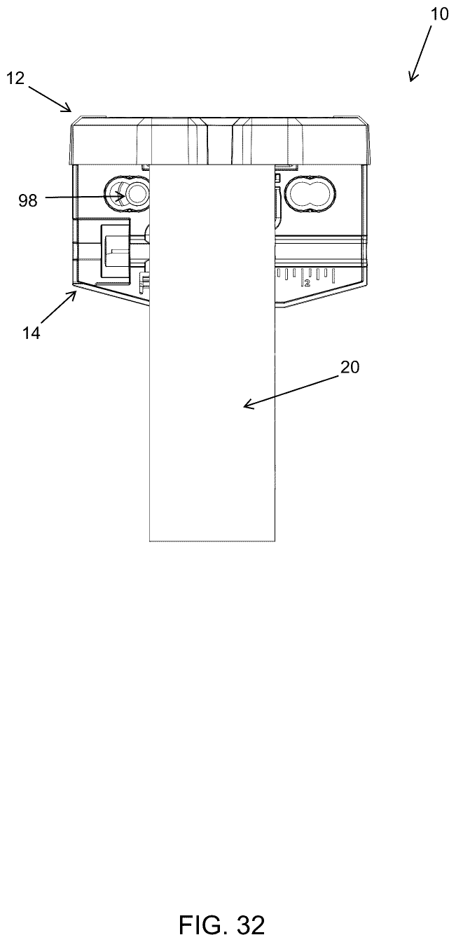

FIG. 33 shows a lower front right view of a doweling jig system shown in FIG. 32, in accordance with one or more arrangements.

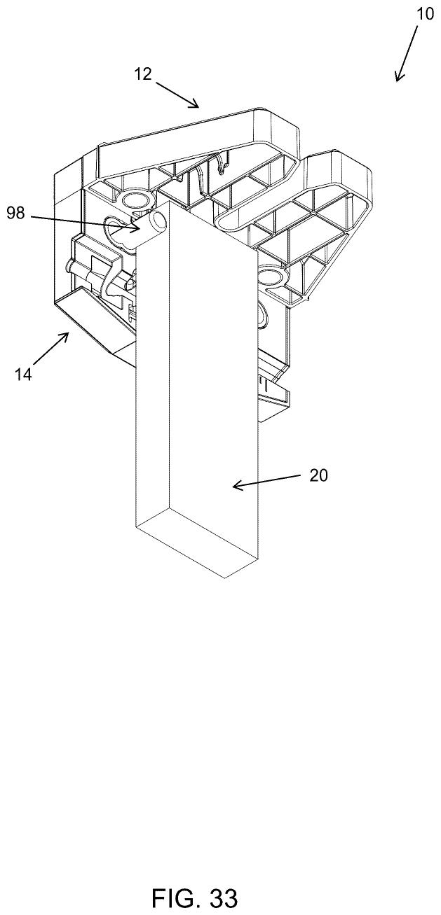

FIG. 34 shows a rear view of a doweling jig system shown in FIG. 32, in accordance with one or more arrangements.

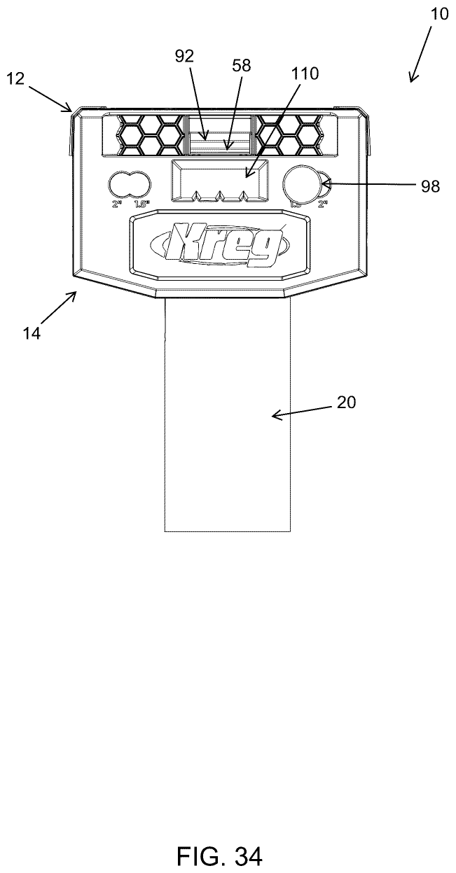

FIG. 35 shows a right side view of a doweling jig system shown in FIG. 32, in accordance with one or more arrangements.

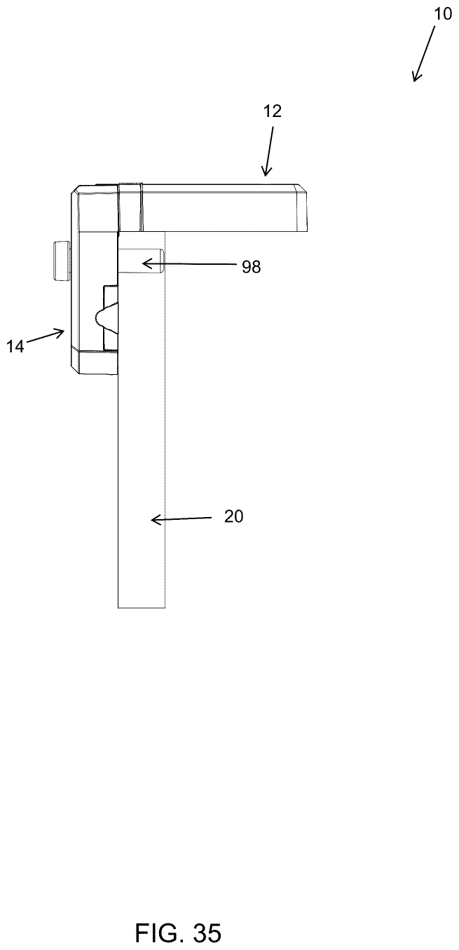

FIG. 36 shows an upper rear right perspective view of a doweling jig system shown in FIG. 32, in accordance with one or more arrangements.

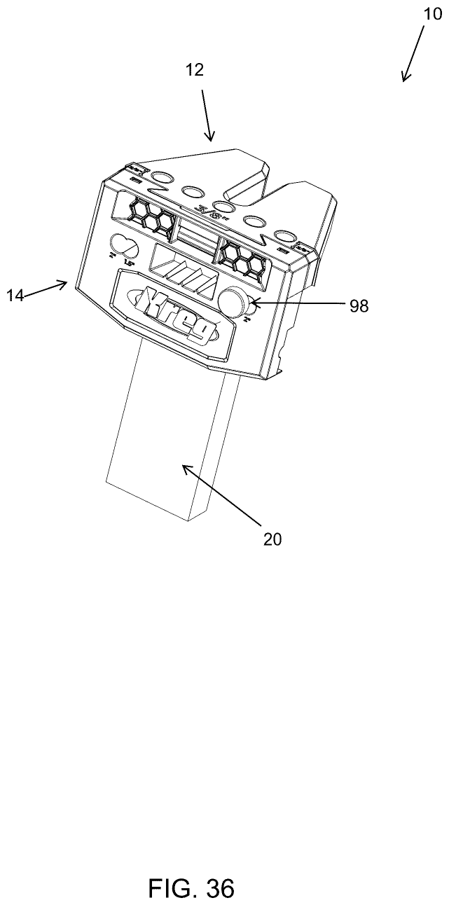

FIG. 37 shows an upper front right perspective view of a doweling jig system, in accordance with one or more arrangements; the view showing a front surface member detached from an alignment member.

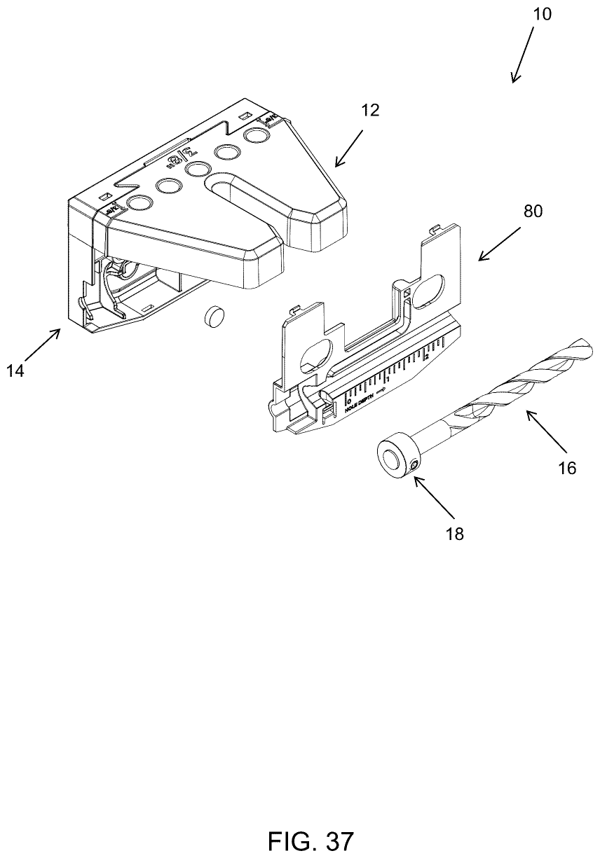

FIG. 38 shows an upper perspective view of a set of different sized drill bits for use with a doweling jig system, in accordance with one or more arrangements.

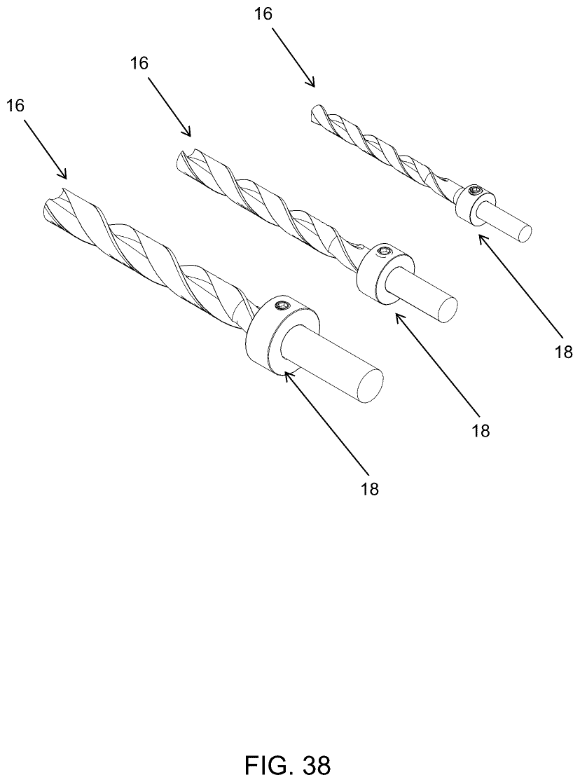

### SUMMARY OF THE DISCLOSURE:

In one or more arrangements, a doweling jig system is presented having a drill guide block and an alignment member operably connected to the drill guide block. The drill guide block includes one or more drill guides. The alignment member is configured to engage a surface of a workpiece component. In one or more arrangements, the alignment member has one or more alignment features configured to facilitate positioning of alignment member along the surface of the workpiece component to facilitate the positioning of the one or more drill guides for drilling a dowel hole in the workpiece component. In one or more arrangements, the drill guide block is selectably detachable from alignment member, for example, for storage, transportation, and/or interchanging between a plurality of different drill guide blocks configured for drilling different size dowel holes.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “either A or B”. As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of dowel joinery. However, the embodiments are not so limited. It is appreciated that the embodiments may be adapted for use in various other applications, which may be improved by the disclosed structures, arrangements and/or methods. The system is merely shown and described as being used in the context of dowel joinery for ease of description and as one of countless examples.

### System 10

With reference to the figures, a doweling jig system 10 (or doweling jig 10 or simply system 10) is presented. The doweling jig system 10 is formed of any suitable size, shape and design and is configured to facilitate drilling dowel holes in various workpieces in various configurations.

### Drill Guide Block 12

Drill guide block 12 is formed of any suitable size, shape, and design and is configured to engage a surface of a workpiece component 20 into which a dowel hole is to be drilled. For ease of explanation, system 10 is primarily described with placement and positioning of drill guide block on an upper surface of a workpiece component 20 for drilling a doweling hole. However, the arrangements are not so limited. Rather, it is understood that in some various arrangements, system 10 may be positioned with drill guide block engaging a side of a work workpiece component 20 for drilling a doweling hole.

In the arrangement shown, as one example, drill guide block 12 an upper surface 24 and a lower surface 26 extending between a forward end 28 and a rearward end 30 and between opposing sides 32. In this example arrangement, lower surface 26 of drill guide block 12 is configured to engage a surface of workpiece component 20.

In the arrangement shown, as one example, the lower surface 26 forms a generally flat and straight surface that is configured to engage a surface workpiece component 20 to facilitate supporting of system 10 thereon for drilling of dowel holes. In the arrangement shown, the generally flat and straight lower surface 26 extends in approximate parallel spaced alignment to the generally flat and straight upper surface 24. In this way, a clamp may engage upper surface 24 to facilitate clamping of drill guide block 12 to a workpiece component 20, thereby providing a strong, durable and rigid connection between system 10 and the workpiece component 20 while drilling. However, such clamping is not required. In some arrangements, forward end 28 of drill guide block 12 provides sufficient counterbalance to place the forward-rearward center of balance of system 10 forward of rearward end 30 of drill guide block so that system 10 will remain in place by way of gravity when system 10 is positioned on along a top edge workpiece component 20 with alignment member in contact with the edge.

However, the arrangements are not so limited. Rather, it is contemplated that in some various arrangements drill guide block 12 may have any alternative shape.

### Drill Guides 40

In one or more arrangements, drill guide block 12 includes a set of drill guides 40. Drill guides 38 are formed of any suitable size, shape, and design, and are configured to guide a drill bit 16 for drilling of dowel holes in workpiece component 20. In the arrangement shown, as one example, drill guides 40 are formed by guide inserts 44 positioned in respective guide channels 42. In this example arrangement, guide channels 42 extend through drill guide block 12 with upper surface 24 to lower surface 26 and in generally perpendicular alignment with upper surface 24 and lower surface 26.

In this example arrangement, a hardened metallic guide insert 44 is positioned in each channel 42. Inserts 44 are formed of any suitable size, shape, and design and are configured to engage and guide a drill bit for drilling of dowel holes. In this example arrangement, guide inserts 44 have a generally cylindrical tube shape having a central bore 48 and extending from an upper edge 50 to a lower edge 52. In one or more arrangements, upper edge 50 of each guide inserts 44 terminates in a shelf or lip which extends outwardly a distance from upper surface 24 of drill guide block 12. The extended upper edge 50 provides an extended stop surface so as to engage and stop a stop collar on a drill bit 16 positioned within bore 48. Similarly, in one or more arrangements, the lower edge 52 of guide inserts 44 may extend beyond lower surface 26 of drill guide block 12 to assist in drilling a clean hole by having an extended surface in contact with or in close tolerances of the workpiece component 20.

In some various different arrangements, guide insert 44 may be connected to held within the drill guide block 12 using various methods and/or means such as molding guide inserts 44 into drill guide block 12, adhesives, two side tape, cementing, screwing, bolting, welding, using fitting features, using snap fitting features, heat-activating, bonding, or the like, or any combination thereof or by connecting by any other manner, method or means.

### Connection Members 58 and 60

In one or more arrangements, drill guide block 12 has a connection member 58 proximate to rearward end 30. Connection member 58 is formed of any suitable size, shape, and design, and is configured to operably connect drill guide block 12 with a connection member 60 of alignment member 14. In the arrangement shown, as one example, connection member 58 of drill guide block 12 is a dovetail configured to mate with a complementary shaped socket of connection member 60 of alignment member 14. However, the arrangements are not so limited. Rather, it is contemplated that in some various arrangements, connection members 58 and 60 may utilize various additional or alternative methods and or means for connecting drill guide block 12 and alignment member 14.

In one or more arrangements, connection members 58 and/or 60 may include connection features 62 to secure connection between connection members 58 and 60.

In the arrangement shown, as one example, connection members 58 and/or 60 have snap fit type connection features 62. More specifically, as is shown, connection member 58 has a protrusion 64 configured to engage and seat within a recess/opening 66 of connection member 60 when connection members 58 and 60 are connected together.

However, the arrangements are not so limited. Rather, it is contemplated that in some various arrangements, connection features 62 connection features 62 may utilize various methods and/or means to secure the connection including but not limited to, for example, snap fit features, friction fittings, threads, pins, screws, bolts, latches, and/or other fasteners, adhesives, bonding, welding, and/or any other method and/or means to secure a connection. For example, in one or more arrangements, connection features 62 may additionally or alternatively include one or more compressible protrusions 68 configured to maintain connection between connection members 58 and/or 60, for example, via friction fitting.

In one or more arrangements, as is shown, connection member 58 and connection member 60 are configured to permit a user to selectably disconnect drill guide block 12 from alignment member 14. In some various arrangements, the ability to disconnect drill guide block 12 from alignment member 14 may provide various benefits. For example, disconnecting drill guide block 12 from alignment member 14 may permit system 10 to be stored and/or transported more easily.

As another example, in some arrangements, system 10 may include a plurality of drill guide blocks 12 that may be interchangeably connected with alignment member 14 as may be useful. For instance, in some arrangements, system 10 may include multiple drill guide blocks 12, each configured for use with different size doweling. Additionally or alternatively, in some arrangements, system 10 may include multiple drill guide blocks 12 with drill guides 40 with different spacing and/or placements.

### Placement of Drill Guides 40

In a preferred embodiment, the center of the bore 48 of guide channels 42 are positioned in equal spacing to one another, such as 1-inch apart. However, in an alternative arrangement, spacing of the guide channels 42 varies. Also, in a preferred embodiment, guide channels 42 are positioned more closely to one of the sides 32 than they are the other.

### Compartment(s) 54

In one or more arrangements, drill guide block 12 of system 10 includes one or more compartments 54 for holding and retaining tools and other objects, which are used in the dowel hole drilling process.

In the arrangement shown, as one example, drill guide block 12 includes a compartment 54 formed in lower surface 26 and configured to hold and retain index pin 100 of index pin system 98 of alignment member 14 when not in use. In this example arrangement, index pin 100 is held within compartment 54 by one or more connection features 56. In the arrangement shown, as one example, connection features 56 are snap fit type connection features 56 to permit index pin 100 to be securely held within compartment 54 while also permitting index pin 100 to be inserted into and removed from compartment 54 without tools. However, the arrangements are not so limited. Rather, it is contemplated that in some various arrangements, connection features 56 may be implemented using any method and/or means for securing index pin 100 within compartment 54.

### Alignment Member 14

Alignment member 14 is formed of any suitable size, shape, and design, and is configured to operably connect with drill guide block 12 and engage a surface of a workpiece component 20 to facilitate the positioning and/or alignment of drill guides 40 for drilling of dowel holes.

In the arrangement shown, as one example, alignment member 14 has a generally rectangular shape with a front surface 80 and a rearward surface 82 extending between an upper end 84 and a lower end 86 and between opposing sides 88.

In the arrangement shown, as one example, the front surface 80 of alignment member 14 forms a generally flat and straight surface that is configured to engage a surface of workpiece component 20 to facilitate alignment of system 10 on an edge of workpiece component 20 for forming dowel holes.

In the arrangement shown, the generally flat and straight front surface 80 extends in approximate parallel spaced alignment to a generally flat and straight rearward surface 82. In this way, a clamp may engage rearward surface 82 to facilitate clamping of drill guide block 12 to a workpiece component 20, thereby providing a strong, durable and rigid connection between system 10 and the workpiece component 20 while drilling.

However, such clamping is not required. Similar to drill guide block 12, in some arrangements, alignment member 14 is configured to hold system 10 in place when alignment member 14 is placed on top of a workpiece component 20. For example, in some arrangements, lower end 86 may extend outward from drill guide block 12 a distance to provide sufficient counterbalance to hold system 10 will remain in place by way of gravity when system 10 is positioned on along a top edge workpiece component 20 with drill guide block 12 in contact with the edge. In this manner, system 10 may be used to drill a dowel hole from the side, if desired.

In the arrangement shown, as one example, upper end 84 of alignment member 14 is configured to attach to rearward end 30 of drill guide block 12 by connection member 60, for example, as described with reference to connection member 58 of drill guide block 12.

In the arrangement shown, alignment member 14 includes an opening 92 extending forward from rearward surface 82 into the connection member 60 of alignment member 14. Opening 92 may be useful, for example to pry the dovetail connection member 58 out of the socket of connection member 60 (e.g., using a flat head screwdriver).

### Alignment Features 96

In one or more arrangements, alignment member 14 includes one or more alignment features 96. Alignment features 96 are formed of any suitable size, shape and design and are configured to provide a visual or physical indication of position of system 10 on workpiece component 20 to align drill guides 40 of drill guide block 12 in a desired position for drilling of dowel holes.

### Alignment Window 110

In one or more arrangements, as is shown, alignment features 96 include an alignment window 110. Alignment window 110 is formed of any suitable size, shape, and design and is configured to facilitate alignment of system 10 with an edge of workpiece component 20. In one or more arrangements, as is shown, alignment window 110 includes a generally rectangular opening extending through alignment member 14 from front surface 80 to rearward surface 82. In one or more arrangements, alignment window 110 includes one or more indicators 112 for alignment with features of a workpiece component 20.

In the example arrangement shown, alignment window 110 includes an indicator 112b positioned to indicate alignment with a center point of one of the drill guides 40. Additionally or alternatively, in or more arrangements, alignment window 110 includes one or more indicators (e.g., 112a and 112c) positioned to indicate alignment with a center point between two of the drill guides 40. Such indicators 112a and 112c may be useful, for example to facilitate positioning of system 10 for drilling of dowel holes on either side of a feature or mark made by a user.

### Index Pin System 98

In one or more arrangements, as is shown, alignment features 96 additionally or alternatively includes an index pin system 98. Index pin system 98 is formed of any suitable size, shape, and design and is configured to facilitate alignment of system 10 with an edge of workpiece component 20 using an index pin 100. In the arrangement shown, index pin system 98 includes an index pin 100 and a set of one or more pin holes 102 configured to receive and hold index pin 100 in one or more positions to facilitate alignment of system 10.

In the arrangement shown, index pin system 98 includes an opening with two semi-circular pin holes 102 extending through alignment member 14 from front surface 80 to rearward surface 82. In this example arrangement, if the index pin 100 is inserted within the leftmost hole 102, indexing a 2″ wide board against the index pin 100 allows the user to center two guide channels 42 within the edge of the board. If the pin is inserted within the rightmost hole 102, indexing a 1.5″wide board against the index pin 100 allows the user to center two guide channels 42 within the edge of the board.

In one or more arrangements, indicators 112 of alignment window 110, are aligned relative to index pin system 98. For example, in one or more arrangements a left indicator 112a is configured to align with an edge of a 2″ board when indexed to an index pin 100 inserted within the leftmost hole 102. The same left indicator 112a is also configured to align with an edge of a 1.5″ wide board when indexed against an index pin 100 inserted into the rightmost hole 102. In this manner indicator 112a provides a quick check to verify that the index pin 100 inserted into the correct hole 102 for the thickness of the board when indexing if the other edge of the board is aligned with the left indicator 112a.

### Compartment(s) 120

In one or more arrangements, alignment member 14 of system 10 includes one or more compartments 120 for holding and retaining tools and other objects, which are used in the dowel hole drilling process.

In the arrangement shown, as one example, a compartment 120 for holding a drill bit is formed in the front surface 80 of alignment member 14. In this example arrangement, compartment 120 has a first section 122, which receives a shaft section of drill bit 16 and a second section 124, which receives a stop collar 18 connected to drill bit 16. In one or more arrangements, first section 122 includes a stepped cylindrical shaped recess 134 extending a length along a width of alignment member 14. The stepped cylindrical shaped recess 134 includes a plurality of cylindrical surfaces 136 corresponding to diameters of a plurality of different size drill bits 16.

For example, in one or more arrangements, stepped cylindrical shaped recess 134 includes a plurality of cylindrical surfaces 136. In the arrangement shown, as one example, the plurality of cylindrical surfaces 136 have respective pairs of the surfaces 136 configured to engage different size drill bits 16, when placed in stepped cylindrical shaped recess 134 so as to hold the drill bit 16 with close and tight tolerances.

In one or more arrangements, a magnet 138 is positioned in alignment member 14 rearward stepped cylindrical shaped recess 134. In this example arrangement, magnet 138 magnetically attracts and holds drill bit 16 in place when placed in stepped cylindrical shaped recess 134.

In one or more arrangements, front surface 80 of alignment member 14 has a set of indicator markings 142 to facilitate positioning of stop collar 18 on drill bit 16 to set drill depth. In this example arrangement, indicator markings 142 are specified relative to the second section 124 of compartment 120, where stop collar 18 is positioned when drill bit 16 is positioned within the first section 122.

The depth of the shelf pin hole is set by adjusting the position of stop collar 18 along the length of drill bit 16. Stop collar 18 is held in place on drill bit 16 by an adjustable locking mechanism (not shown) such as a locking screw or a plurality of locking screws, or the like, that pass through the stop collar 18 and engage the shaft of drill bit 16 thereby adjustably setting the depth of the shelf pin hole. The depth can easily be set using the doweling jig 10 by placing the drill bit 16 and stop collar 18 into compartment 120, with stop collar 18 positioned in the second section 124 and the drill bit 16 extending into first section 122. In this position, the locking screw of stop collar 18 is loosened (if not already) and drill bit 16 is moved right or left within first section 122 of compartment 120 to align a tip of drill bit 16 with an indicator marking 142 for the desired dowel hole depth. The locking screw of stop collar 18 is then tightened and drill bit 16 and stop collar 18 are ready for use.

### Materials and Construction

In one or more arrangements, drill guide block 12, alignment member 14, and/or other components of system 10 are formed of any materials having suitable durability and strength for clamping onto workpiece components 20, drilling of dowel holes, and accidental drops, falls, and/or other handling expected in a workshop. Such materials may include but are not limited to for example, metallic materials, rigid plastic, composite materials, other non-metallic materials or a combination thereof. In one or more arrangements, as one example, drill guide block 12 and/or alignment member 14 are formed of a plastic material or composite material in a molding process or the like to provide strength, rigidity, permanence. and accuracy.

In one or more arrangements, drill guide block 12 and alignment member 14 are separate components, as is shown. However, embodiments are not so limited. Rather, it is contemplated that drill guide block 12, alignment member 14, and/or various other components of system 10 may be formed by any number of components. For example, in one or more arrangements, drill guide block 12 and alignment member 14 may be formed as a single unitary component.

In the arrangement shown, as one example, drill guide block 12, alignment member 14, and/or other components are formed of a hollow core construction having hollow cells 150 formed by interconnecting support structures 152 that extend between exterior walls 154 of the drill guide block 12 and/or alignment member 14. Such construction helps to reduce weight and material cost while retaining relatively high compression and sheer properties. In this example arrangement, support structures 152 are arranged to form hollow rectangular shaped cells 150. However, embodiments are not so limited. Rather, it is contemplated that drill guide block 12, alignment member 14, and/or various other components of system 10 may be formed with cells 150 of any shape (e.g., round, square, triangular, rectangular, hexagonal, honeycomb or the like) or may be formed of solid core construction without any cells 150.

### Grip Material 158

In one or more arrangements, system 10 includes grip material 158 (not shown) on one or more surfaces to improve contact with workpiece component 20 in which dowel holes are to be drilled.

That is, in use the lower surface 26 of drill guide block 12 and/or on front surface 80 of alignment member 14 engage the surface of a workpiece component 20. It is highly desirable that once the system 10 is placed in proper position on the workpiece component 20 that the system 10 does not move during a drilling operation. If the system 10 moves during a drilling operation this can ruin the dowel hole and/or the workpiece component 20 as well as cause injury. As such, it is important that the system 10 not move after clamping. However, the small size of system 10, which correlates with a small surface area of contact between system 10 and workpiece component 20 makes it difficult to firmly hold the system 10 in place.

To provide maximum durability and strength and rigidity and ruggedness, the drill guide block 12 and/or alignment member 14 may be primarily formed of a hard material such as a plastic material, composite material, a nylon material, a fiber glass material or any other non-metallic material, or combination thereof. Alternatively, a metallic material is used which has superb hardness, but a low coefficient of friction. Alternatively, a combination of metallic material and non-metallic material is used. While hard materials are good for durability, strength, rigidity and ruggedness, hard materials tend to have a low coefficient of friction. That is, hard materials tend to slide easily when placed on a surface or other object. The easier the system 10 slides when placed on workpiece component 20, the more pressure must be applied to keep the workpiece component in place during drilling.

To correct this problem, in one or more arrangements, system 10 has grip material formed on lower surface 26 of drill guide block 12 and/or on front surface 80 of alignment member 14. Additionally or alternatively, in some arrangements, system 10 includes grip material 158 on one or more surfaces to improve contact with clamps (e.g., when clamps are used to clamp system 10 to workpiece component 20). For example, in one or more arrangements, system 10 has grip material formed 158 on upper surface 24 of drill guide block 12 and/or on rearward surface 82 of alignment member 14.

This grip material 158 has a higher coefficient of friction than the material that primarily forms the drill guide block 12 and/or alignment member 14. Coefficient of friction describes the ratio of the force of friction between two bodies and the force pressing them together. The higher the coefficient of friction, the more force is required to cause the two bodies to slide with respect to one another. One drawback to using a material that has a high coefficient of friction, such as a compressible rubber or composite material, is that the higher the coefficient of friction the less-durable the material tends to be. As such, by forming drill guide block 12 and/or alignment member 14 primarily of a harder material that is strong and durable (but has a lower coefficient of friction) and placing a grip material 158 on one or more contact surfaces that has a higher coefficient of friction is the best of both worlds in that this provides a system 10 that is hard and durable while also having a high coefficient of friction.

Grip material 158 may be attached to drill guide block 12 and/or alignment member 14 by any manner, method or means. In one arrangement, grip material is adhered to drill guide block 12 and/or alignment member 14. In another arrangement, grip material 158 is molded into or onto drill guide block 12 and/or alignment member 14 in a dual-molding or dual durometer molding manner. In one or more arrangements, grip material may be sprayed onto or deposited onto drill guide block 12 and/or alignment member 14. In some various arrangements, grip material 158 may extend across an entire surface of drill guide block 12 and/or alignment member 14 or may cover one or more portions of such surfaces.

From the above discussion it will be appreciated that the doweling jig system and related method of use, presented herein improves upon the state of the art.

Specifically, the doweling jig system presented: provides improved functionality over prior art systems; provides improved features over prior art systems; is relatively inexpensive; is easy to use; is intuitive to use; is strong and robust; can be used in many applications;; provides unique functionality; is fast to use and fast to set-up; is safe to use; saves time; has a compact size; is adjustable, in depth as well as width; has a long useful life; is high quality; improves efficiencies; and/or improves the quality of the products made using the device, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A doweling jig system, comprising:
a drill guide block;
the drill guide block having one or more drill guides;
an alignment member;
the alignment member operably connected to the drill guide block;
the alignment member configured to engage a surface of a workpiece component;
wherein the alignment member has one or more alignment features;
wherein the one or more alignment features are configured to facilitate positioning of alignment member along the surface of the workpiece component to facilitate the positioning of the one or more drill guides for drilling a dowel hole in the workpiece component.

2. The system of claim 1, wherein the one or more alignment features includes an index pin system;
the index pin system configured to engage an edge of the workpiece component to facilitate the positioning of the one or more drill guides for drilling the dowel hole.

3. The system of claim 1, wherein the one or more alignment features includes an index pin system;
the index pin system having an index pin;
the index pin system having one or more index pin holes configured to receive and hold the index pin;
wherein when the index pin is held in one of the one or more index pin holes, the index pin is positioned to engage an edge of the workpiece component to facilitate the positioning of the one or more drill guides for drilling the dowel hole.

4. The system of claim 1, wherein the one or more alignment features includes an index pin system;
the index pin system having an index pin;
the index pin system having a plurality of index pin holes configured to receive and hold the index pin;
the plurality of index pin holes including a first index pin hole and a second index pin hole;
wherein when the index pin is held in the first index pin hole, the index pin is positioned to facilitate the positioning of the one or more drill guides for drilling the dowel hole in a workpiece component having a first thickness;
wherein when the index pin is held in the second index pin hole, the index pin is positioned to facilitate the positioning of the one or more drill guides for drilling the dowel hole in a workpiece component having a second thickness;
wherein the first thickness is different from the second thickness.

5. The system of claim 1, wherein the one or more alignment features includes an index pin system;
the index pin system having an index pin;
the index pin system having one or more index pin holes configured to receive and hold the index pin;
wherein when the index pin is held in one of the one or more index pin holes, the index pin is positioned to engage an edge of the workpiece component to facilitate the positioning of the one or more drill guides for drilling the dowel hole;
wherein the drill guide block includes a compartment configured to receive and hold the index pin when not in use.

6. The system of claim 1, wherein the one or more alignment features includes an index pin system;
the index pin system having an index pin;
the index pin system having one or more index pin holes configured to receive and hold the index pin;
wherein when the index pin is held in one of the one or more index pin holes, the index pin is positioned to engage an edge of the workpiece component to facilitate the positioning of the one or more drill guides for drilling the dowel hole;
wherein the alignment member includes a compartment configured to receive and hold the index pin when not in use.

7. The system of claim 1, wherein the one or more alignment features includes an alignment window formed in the alignment member.

8. The system of claim 1, wherein the one or more alignment features includes an alignment window formed in the alignment member;
wherein the alignment window includes one or more indicators for visual alignment with the workpiece component to facilitate the positioning of the one or more drill guides for drilling the dowel hole in a workpiece component having a second thickness.

9. The system of claim 1, wherein the one or more alignment features includes an alignment window formed in the alignment member;
wherein the alignment window includes one or more indicators for visual alignment with the workpiece component to facilitate the positioning of the one or more drill guides for drilling the dowel hole in a workpiece component having a second thickness;
wherein the one or more indicators are protrusions extending into the alignment window.

10. The system of claim 1, wherein the alignment member includes a compartment configured to receive and hold a drill bit for drilling the dowel hole when not in use.

11. The system of claim 1, wherein the drill guide block includes a compartment configured to receive and hold a drill bit for drilling the dowel hole when not in use.

12. The system of claim 1, wherein the alignment member includes a compartment configured to receive and hold a drill bit for drilling the dowel hole when not in use;
wherein the compartment includes a stepped cylindrical shaped recess configured to receive and hold drill bits of a plurality of different sizes.

13. The system of claim 1, wherein the drill guide block includes a compartment configured to receive and hold a drill bit for drilling the dowel hole when not in use;
wherein the compartment includes a magnet configured to magnetically hold the drill bit within the compartment.

14. A doweling jig system, comprising:
a first drill guide block;
the first drill guide block having one or more drill guides;
an alignment member;
the alignment member configured to facilitate positioning of alignment member along a surface of a workpiece component to facilitate the positioning of the one or more drill guides for drilling a dowel hole in the workpiece component;
the first drill guide block having a first connection member;
the alignment member having a second connection member;
the first connection member and the second connection member configured to connect with one another to operably connect alignment member with the first drill guide block;
the first connection member and the second connection member configured to detach from one another to disconnect alignment member from the first drill guide block.

15. The system of claim 14, wherein the one or more drill guides of the first drill guide block are configured for drilling of dowel holes of a first diameter;
the system further comprising a second drill guide block;
the second drill guide block having one or more drill guides;
the second drill guide block having a third connection member;
the third connection member and the second connection member configured to connect with one another to operably connect alignment member with the second drill guide block;
the third connection member and the second connection member configured to detach from one another to disconnect alignment member from the second drill guide block;
wherein the one or more drill guides of the second drill guide block are configured for drilling of dowel holes of a second diameter;
wherein the second diameter is different from the first diameter.

16. The system of claim 14, wherein the alignment member has one or more alignment features;
wherein the one or more alignment features are configured to facilitate positioning of alignment member along the surface of the workpiece component to facilitate the positioning of the one or more drill guides for drilling a dowel hole in the workpiece component;
wherein the one or more alignment features includes an index pin system;
the index pin system configured to engage an edge of the workpiece component to facilitate the positioning of the one or more drill guides for drilling the dowel hole.

17. The system of claim 14, wherein the alignment member has one or more alignment features;
wherein the one or more alignment features are configured to facilitate positioning of alignment member along the surface of the workpiece component to facilitate the positioning of the one or more drill guides for drilling a dowel hole in the workpiece component;
wherein the one or more alignment features includes an index pin system;
the index pin system having an index pin;
the index pin system having one or more index pin holes configured to receive and hold the index pin;
wherein when the index pin is held in one of the one or more index pin holes, the index pin is positioned to engage an edge of the workpiece component to facilitate the positioning of the one or more drill guides for drilling the dowel hole.

18. The system of claim 14, wherein the alignment member has one or more alignment features;
wherein the one or more alignment features are configured to facilitate positioning of alignment member along the surface of the workpiece component to facilitate the positioning of the one or more drill guides for drilling a dowel hole in the workpiece component;
wherein the one or more alignment features includes an index pin system;
the index pin system having an index pin;
the index pin system having a plurality of index pin holes configured to receive and hold the index pin;
the plurality of index pin holes including a first index pin hole and a second index pin hole;
wherein when the index pin is held in the first index pin hole, the index pin is positioned to facilitate the positioning of the one or more drill guides for drilling the dowel hole in a workpiece component having a first thickness;
wherein when the index pin is held in the second index pin hole, the index pin is positioned to facilitate the positioning of the one or more drill guides for drilling the dowel hole in a workpiece component having a second thickness;
wherein the first thickness is different from the second thickness.

19. The system of claim 14, wherein the alignment member has one or more alignment features;
wherein the one or more alignment features are configured to facilitate positioning of alignment member along the surface of the workpiece component to facilitate the positioning of the one or more drill guides for drilling a dowel hole in the workpiece component;
wherein the one or more alignment features includes an index pin system;
the index pin system having an index pin;
the index pin system having one or more index pin holes configured to receive and hold the index pin;
wherein when the index pin is held in one of the one or more index pin holes, the index pin is positioned to engage an edge of the workpiece component to facilitate the positioning of the one or more drill guides for drilling the dowel hole;
wherein the drill guide block includes a compartment configured to receive and hold the index pin when not in use.

20. The system of claim 14, wherein the alignment member has one or more alignment features;
wherein the one or more alignment features are configured to facilitate positioning of alignment member along the surface of the workpiece component to facilitate the positioning of the one or more drill guides for drilling a dowel hole in the workpiece component;
wherein the one or more alignment features includes an index pin system;
the index pin system having an index pin;
the index pin system having one or more index pin holes configured to receive and hold the index pin;
wherein when the index pin is held in one of the one or more index pin holes, the index pin is positioned to engage an edge of the workpiece component to facilitate the positioning of the one or more drill guides for drilling the dowel hole;
wherein the alignment member includes a compartment configured to receive and hold the index pin when not in use.

21. The system of claim 14, wherein the alignment member has one or more alignment features;
wherein the one or more alignment features are configured to facilitate positioning of alignment member along the surface of the workpiece component to facilitate the positioning of the one or more drill guides for drilling a dowel hole in the workpiece component;
wherein the one or more alignment features includes an alignment window formed in the alignment member.

22. The system of claim 14, wherein the alignment member has one or more alignment features;
wherein the one or more alignment features are configured to facilitate positioning of alignment member along the surface of the workpiece component to facilitate the positioning of the one or more drill guides for drilling a dowel hole in the workpiece component;
wherein the one or more alignment features includes an alignment window formed in the alignment member;
wherein the alignment window includes one or more indicators for visual alignment with the workpiece component to facilitate the positioning of the one or more drill guides for drilling the dowel hole in a workpiece component having a second thickness.

23. The system of claim 14, wherein the alignment member has one or more alignment features;
wherein the one or more alignment features are configured to facilitate positioning of alignment member along the surface of the workpiece component to facilitate the positioning of the one or more drill guides for drilling a dowel hole in the workpiece component;
wherein the one or more alignment features includes an alignment window formed in the alignment member;
wherein the alignment window includes one or more indicators for visual alignment with the workpiece component to facilitate the positioning of the one or more drill guides for drilling the dowel hole in a workpiece component having a second thickness;
wherein the one or more indicators are protrusions extending into the alignment window.

24. The system of claim 14, wherein the alignment member includes a compartment configured to receive and hold a drill bit for drilling the dowel hole when not in use.

25. The system of claim 14, wherein the drill guide block includes a compartment configured to receive and hold a drill bit for drilling the dowel hole when not in use.

26. The system of claim 14, wherein the alignment member includes a compartment configured to receive and hold a drill bit for drilling the dowel hole when not in use;
wherein the compartment includes a stepped cylindrical shaped recess configured to receive and hold drill bits of a plurality of different sizes.

27. The system of claim 14, wherein the drill guide block includes a compartment configured to receive and hold a drill bit for drilling the dowel hole when not in use;
wherein the compartment includes a magnet configured to magnetically hold the drill bit within the compartment.
